(19) United States
(12) Patent Application Publication
(10) Pub. No.: US 2011/0101860 A1
(43) Pub. Date: May 5, 2011

(54) DISCHARGE LAMP, MANUFACTURING METHOD THEREOF, AND PROJECTOR

(75) Inventor: Yoshihide NISHIYAMA, Chino-shi (JP)

(73) Assignee: SEIKO EPSON CORPORATION, Tokyo (JP)

(21) Appl. No.: 12/910,269

(22) Filed: Oct. 22, 2010

(30) Foreign Application Priority Data
Oct. 30, 2009 (JP) 2009-251121

(51) Int. Cl. H01J 61/35; H01J 9/00

(52) U.S. Cl. 313/635; 445/58

(57) ABSTRACT

A discharge lamp that includes an arc tube made from silica glass, and a modified layer as a boron- or germanium-diffused layer formed in an inner surface of the arc tube.

### BACKGROUND

1. Technical Field

The present invention relates to a discharge lamp, manufacturing method thereof, and a projector.

2. Related Art

Projectors are image projecting apparatuses used in many different applications, such as in conference presentations and home theaters. The light source unit of such projectors is generally a discharge lamp with electrodes such as a halogen lamp, a metal halide lamp, and a high-pressure mercury lamp.

However, the discharge lamp is problematic in that the high emission temperature causes a phenomenon known as devitrification, in which the silica glass used as the material of the arc tube is crystallized to lower transmitted light or the strength of the arc tube. As a solution to this problem, it has been proposed to provide a protective film inside the arc tube, using a cubic crystalline boron nitride (c-BN) thin film (JP-A-6-333535; Patent Document 1), a silicon boronitride (SiBN) thin film (Japanese Patent No. 3467939; Patent Document 2), and materials such as yttrium oxide (JP-A-2008-270074; Patent Document 3).

However, both Patent Documents 1 and 2 use chemical vapor deposition (CVD) as the deposition method, and thus there are difficulties in uniformly depositing the film on the inner surface of the arc tube. The use of the yttrium oxide protective film is problematic, because it causes devitrification during emission and lowers transmitted light.

### SUMMARY

An advantage of some aspects of the invention is to provide a discharge lamp that can effectively suppress devitrification of the arc tube over extended time periods, and that can prevent lowering of transmitted light and arc tube strength to greatly improve the lifetime of the lamp. Another advantage is to provide a manufacturing method of such discharge lamps, and a light source unit and a projector.

A discharge lamp according to an aspect of the invention includes an arc tube made from silica glass, and a modified layer as a boron- or germanium-diffused layer formed in an inner surface of the arc tube.

According to the aspect of the invention, by the provision of the modified layer as a boron- or germanium-diffused layer formed in the inner surface of the arc tube made from silica glass, the devitrification (crystallization) due to the heat of the emitting lamp can be suppressed, and transmitted light and arc tube strength can be prevented from lowering, making it possible to greatly improve lamp lifetime.

It is preferable that the modified layer be a (Si—B—O) layer or a (Si—Ge—O) layer.

According to the aspect of the invention, the modified layer provided as a (Si—B—O) layer or a (Si—Ge—O) layer has high translucency, and excels in chemical stability and heat resistance, and thus does not readily undergo changes in property even under the high temperature of the lamp during use.

It is preferable that the modified layer be exposed to an emission space of the arc tube.

According to the aspect of the invention, because the modified layer is exposed to the emission space of the arc tube, defects such as detachment due to improper adhesion to the arc tube as might occur in the deposition of a boron-containing film on the inner surface of the arc tube can be prevented. The effect of suppressing devitrification is thus ensured over extended time periods.

It is preferable that the modified layer have a distribution of boron or germanium concentration that gradually becomes lower towards inside away from an outermost layer of the inner surface of the arc tube.

According to the aspect of the invention, because the modified layer has a distribution of boron or germanium concentration that gradually becomes lower towards inside away from an outermost layer of the inner surface of the arc tube, devitrification can be suppressed with the modified layer formed only in the vicinity of the very surface of the inner surface of the arc tube.

It is preferable that the modified layer has boron or germanium concentration gradient that exponentially becomes lower towards inside away from an outermost layer of the inner surface.

According to the aspect of the invention, because the modified layer has boron or germanium concentration gradient that exponentially becomes lower towards inside away from an outermost layer of the inner surface, devitrification can be suppressed further.

It is preferable that the modified layer has a thickness of 0.01 μm or more and 1 μm or less.

According to the aspect of the invention, a good devitrification-suppressing effect cannot be expected with the modified layer thickness of less than 0.01 μm. The thickness above 1 μm adds time to manufacturing the modified layer.

It is preferable that the modified layer have a thickness of 0.02 μm or more and 0.5 μm or less.

According to the aspect of the invention, a high devitrification-suppressing effect can be expected, and thus high emission efficiency can be maintained for extended time periods.

A discharge lamp manufacturing method according to another aspect of the invention includes applying a boron-containing liquid material on an inner surface of a silica glass arc tube, and diffusing the boron into the inner surface of the arc tube by heat treatment.

According to the aspect of the invention, a boron-containing liquid material is applied on the inner surface of the arc tube made from silica glass, and the boron is diffused into the inner surface of the arc tube by heat treatment. This forms a modified layer as a boron-diffused layer in the inner surface of the arc tube. The modified layer can suppress the devitrification (crystallization) due to the heat of the emitting lamp, and can prevent the amount of transmitted light and arc tube strength from lowering, making it possible to greatly improve lamp lifetime.

It is preferable that the liquid material be diboron trioxide.

According to the aspect of the invention, because the boron-containing liquid material is diboron trioxide, a (Si—B—O) modified layer is formed in the inner surface of the arc tube. The (Si—B—O) modified layer has high translucency, and excels in chemical stability and heat resistance, and thus does not readily undergo changes in property even under the high temperature of the lamp during use.

It is preferable that the liquid material be boron trifluoride diethyl etherate.

According to the aspect of the invention, because the liquid material is boron trifluoride diethyl etherate ((C₂H₅)₂O.BF₃), a chemically stable (Si—B—O) modified layer can be formed in the inner surface of the arc tube. Because the modified layer is formed in the tube wall of the arc tube, defects such as detachment due to improper adhesion to the arc tube as might occur in the deposition of a devitrification-suppressing film on the inner surface of the arc tube can be prevented.

It is preferable that the method further include exposing a modified layer by removing a B₂O₃ film formed by a heat treatment that follows the application of the boron-containing liquid material on the inner surface of the arc tube; and installing a tungsten electrode in the arc tube.

According to the aspect of the invention, because the modified layer is exposed by removing a B₂O₃ film formed by a heat treatment that follows the application of the boron-containing liquid material on the inner surface of the arc tube, the boron does not evaporate from the B₂O₃ film under the high emission temperature of the lamp. Boron can deteriorate the tungsten electrode installed in the arc tube. Thus, by removing such a risk factor beforehand, the lifetime of the electrode can be extended.

A discharge lamp manufacturing method according to still another aspect of the invention includes flowing a boron-containing gas or a germanium-containing gas into an arc tube made from silica glass, and causing the flow of the boron-containing gas or a germanium-containing gas to undergo pyrolysis in the arc tube so as to diffuse the boron into an inner surface of the arc tube.

According to the aspect of the invention, because the flow of the boron-containing gas or a germanium-containing gas flown into a arc tube made from silica glass is caused to undergo pyrolysis in the arc tube so as to diffuse the boron or the germanium into an inner surface of the arc tube, the boron or the germanium produced by the pyrolysis reacts with the inner surface of the arc tube and diffuses into the tube wall, and a modified layer is formed in the inner surface of the arc tube. Because the flow rate of the boron-containing gas or the germanium-containing gas flown into the arc tube can be readily controlled, the extent of boron or germanium diffusion in the inner surface of the arc tube can be adjusted, and the modified layer can be formed in a desired thickness in the inner surface of the arc tube.

It is preferable that the boron-containing gas be any one of boron trichloride gas, boron trifluoride gas, and boron tribromide gas.

According to the aspect of the invention, because the boron-containing gas is any one of boron trichloride gas, boron trifluoride gas, and boron tribromide gas, it is ensured that the modified layer as a boron-modified layer is formed in the outermost layer of the inner surface of the arc tube. Further, only the modified layer can be formed in the inner surface of the arc tube.

It is preferable that the germanium-containing gas be any one of monogermane (GeH₄) gas, digermane (Ge₂H₆) gas, and trigermane (Ge₃H₈) gas.

According to the aspect of the invention, a (Si—Ge—O) modified layer is formed in the inner surface of the arc tube. The (Si—Ge—O) modified layer has high translucency, and excels in chemical stability and heat resistance, and thus does not easily undergo changes in property even under the high temperature of the lamp during use.

Because devitrification of the discharge lamp can be suppress for extended time periods, highly bright illumination light can be emitted over extended time periods.

A projector according to further another aspect of the invention includes the discharge lamp of the aspect of the invention.

Because devitrification of the discharge lamp can be suppress for extended time periods, highly bright illumination light can be emitted over extended time periods, and the projector according to the aspect of the invention includes the discharge lamp, a high-quality, reliable projection image can be obtained.

### BRIEF DESCRIPTION OF THE DRAWINGS

The invention will be described with reference to the accompanying drawings, wherein like numbers reference like elements.

FIG. 1 is a cross sectional view illustrating a schematic structure of a light source unit of First Embodiment of the invention.

FIG. 2 is a cross sectional view illustrating a schematic structure of a discharge lamp of First Embodiment of the invention.

FIG. 3 is a magnified cross section of an arc tube.

FIG. 4 is a graph representing a diffused state of boron.

FIG. 5 is a flowchart representing manufacturing steps of the discharge lamp of First Embodiment of the invention.

FIGS. 6A and 6B are magnified partial cross sectional views of an arc tube in manufacturing steps of the discharge lamp of First Embodiment of the invention.

FIG. 7 is a graph representing an example of the diffused state (concentration gradient) of boron.

FIGS. 8A and 8B are magnified cross sectional views illustrating a relevant portion of an arc tube in manufacturing steps of a discharge lamp of Variation 1 of the invention.

FIG. 9A is a flowchart representing manufacturing steps of a discharge lamp of Variation 2 of the invention; FIG. 9B is a magnified cross sectional view illustrating a relevant portion of an arc tube in a manufacturing step of the discharge lamp of Variation 2 of the invention.

FIG. 10A is a cross sectional view illustrating a schematic structure of a discharge lamp of Second Embodiment of the invention; FIG. 10B is a magnified cross sectional view illustrating a relevant portion of the discharge lamp.

FIG. 11 is a flowchart representing a manufacturing method of the discharge lamp of Second Embodiment of the invention.

FIGS. 12A to 12C are magnified cross sectional views illustrating a relevant portion of an arc tube in manufacturing steps.

FIG. 13A is a photographic view showing the initial state of an electrode before lighting a lamp;

FIG. 13B is a photographic view showing the deteriorated state of the electrode after the lighting time of 500 H.

FIGS. 14A and 14B are cross sectional views illustrating a schematic structure of a discharge lamp of Third Embodiment of the invention.

FIG. 15A is a flowchart representing a manufacturing method of the discharge lamp of Third Embodiment of the invention; FIG. 15B is a magnified cross sectional view illustrating a relevant portion of an arc tube in a manufacturing step.

FIG. 16 is a diagram illustrating a schematic structure of a projector.

### DESCRIPTION OF EXEMPLARY EMBODIMENTS

Embodiments of the invention are described below with reference to the accompanying drawings. Note that the members in the drawings referred to in the following descriptions are shown in different scales, as appropriate, for clarity.

### First Embodiment

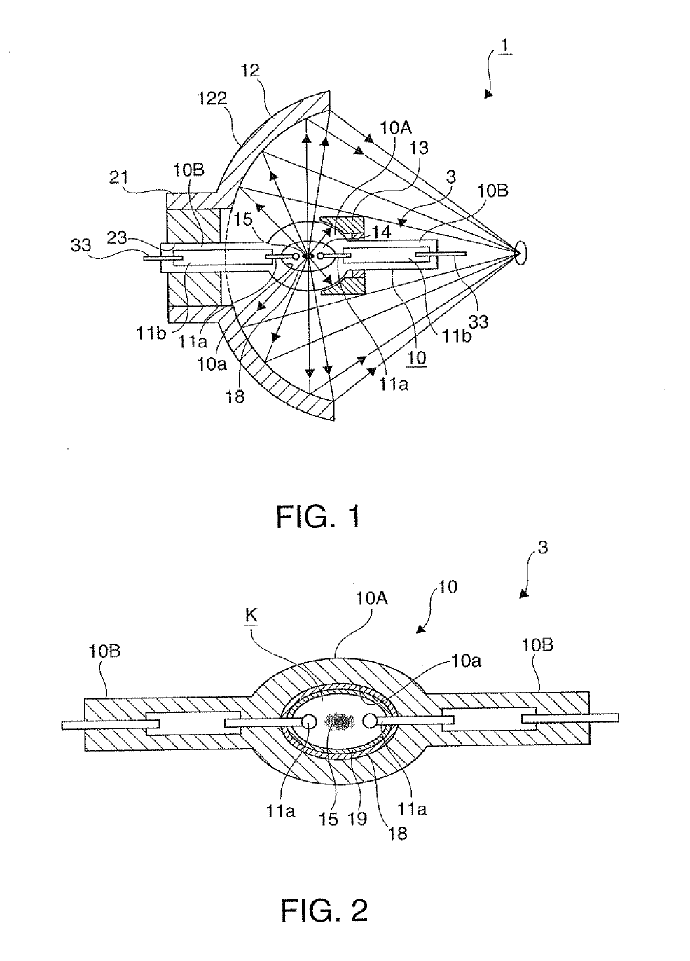

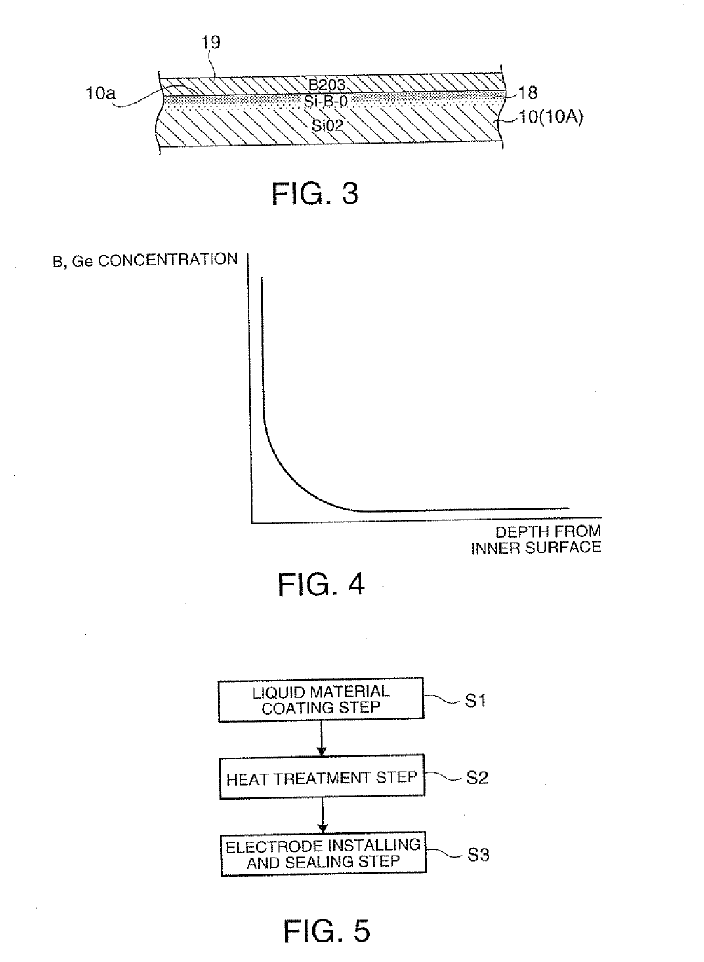

FIG. 1 is a cross sectional view illustrating a schematic structure of a light source unit according to an embodiment of the invention. FIG. 2 is a cross sectional view illustrating a schematic structure of a discharge lamp. FIG. 3 is a magnified cross sectional view of an arc tube 10. FIG. 4 is a graph representing a diffused state of boron.

A light source unit 1 of the present embodiment is suitably used for a projector (described later), and includes, as illustrated in FIG. 1, reflector 12, and a discharge lamp 3 disposed inside the reflector 12. The discharge lamp 3 includes an arc tube made from silica glass (SiO₂), and a pair of electrodes 11a, 11a disposed in the arc tube 10. Luminescent material is sealed inside the arc tube 10.

As illustrated in FIG. 2, the arc tube 10 includes a swelled portion 10A that spherically-swelled at the center, and sealing portions 10B, 10B that extend out from the sides of the swelled portion 10A. An emission region 14 charged with luminescent material is formed inside the swelled portion 10A (sealed space that enclosed luminescent gas). The emission region 14 has an inner diameter of, for example, about 1 mm to 2 mm.

Inside the sealing portions 10B, 10B, rod-like electrodes 11a, 11a are disposed with their ends separated from each other. The electrodes 11a, 11a are conductive material, for which materials having a small coefficient of thermal expansion and high heat-resistance, specifically, tungsten, are suitably used.

A metal foils 11b of molybdenum electrically connected to the electrodes 11a, 11a are inserted in the sealing portions 10B, 10B, and sealed with glass material or the like. The metal foils 11b are also connected to lead lines 33 (electrode extracting lines) that stick out of the discharge lamp 3.

Mercury, noble gas, and halogen compounds can be used as the luminescent material charged inside the emission region 14. Preferably, mercury is used in an amount of, for example, 0.15 mg/mm³ to 0.32 mg/mm³, and sealed under the vapor pressure of 150 bar to 190 bar.

Noble gas is used to assist emission in the emitter. Non-limiting examples of noble gas include commonly used argon gas and xenon gas.

Among chlorine, bromine, and iodine, preferably bromine can be used for the halogen compounds.

As illustrated in FIG. 3 and FIG. 4, the arc tube 10 of the present embodiment includes a modified layer 18 formed in an inner surface 10a of the swelled portion 10A to suppress devitrification of the arc tube 10.

As illustrated in FIG. 3, the modified layer 18 is a boron-diffused layer in the inner surface 10a of the arc tube 10. In the present embodiment, the modified layer 18 is an (Si—B—O) layer. The modified layer 18 is formed only in the outermost layer portion of the inner surface 10a, and has a distribution of a boron concentration that gradually decreases from the outermost layer of the inner surface 10a of the arc tube 10 towards inside (along the thickness direction of the tube wall; FIG. 4). Preferably, the boron concentration has a concentration gradient that decreases exponentially.

The modified layer 18 has a thickness of, for example, 0.01 μm or more and 1 μm or less, though it depends on such factors as the type of the luminescent material sealed in the arc tube 10. The preferable thickness of the modified layer 18 is 0.02 μm or more and 0.5 μm or less.

With the modified layer 18 formed at the very surface of the inner surface 10a of the arc tube 10, the arc tube 10 can be prevented from crystallizing, making it possible to suppress devitrification of the arc tube 10 for extended time periods.

A B₂O₃ film 19 is formed on the modified layer 18, covering the whole surface of the modified layer 18. The B₂O₃ film 19 has a thickness of, for example, 0.1 μm or more and 10 μm or less, preferably 0.2 μm or more and 5 μm or less.

The reflector 12 is a glass-made molded product integral with a neck-like portion 21 through which the sealing portions 10B of the discharge lamp 3 are inserted, and a reflecting portion 22 that has a curved surface spreading out from the neck-like portion 21.

The neck-like portion 21 has an insertion opening 23 at the center, and the sealing portion 10B is disposed at the center of the insertion opening 23.

The reflecting portion 22 is configured to include a metallic thin film vapor-deposited on the curved glass inner surface. The reflecting face of the reflecting portion 22 serves as a cold mirror that reflects visible light and transmits infrared rays.

The discharge lamp 3 is disposed inside the reflecting portion 22 in such a manner that the emission center between the electrodes 11a inside the swelled portion 10A coincides with the focal position of the curved surface of the reflecting portion 22.

With the discharge lamp 3 turned on, as illustrated in FIG. 1, the light beam that radiates from the swelled portion 10A is reflected at the reflecting face of the reflecting portion 22, and becomes parallel rays.

The discharge lamp 3 is fixed onto the reflector 12 by inserting the sealing portion 10B of the discharge lamp 3 into the insertion opening 23 of the reflector 12, and by charging the insertion opening 23 with an inorganic adhesive that contains silica and alumina as the main components.

A secondary reflector 13 is a reflecting member covering the light emerging front side of the emission region 14 of the swelled portion 10A. The secondary reflector 13 has a concave reflecting face conforming to the spherical surface of the emission region 14 (the inner surface 10a of the arc tube 10), and that serves as a cold mirror as does the reflector 12. Preferably, the secondary reflector 13 covers ⅓ or more and not more than about half of the light emerging front side of the emission region 14 of the swelled portion 10A.

Applying voltage to the lead lines 33 sticking out of the sealing portion 10B in the discharge lamp 3 causes discharge across the electrodes 11a, 11a, and an emitter 15 emits light. Some of the light beam emitted forward from the swelled portion 10A of the discharge lamp 3 is reflected at the reflecting face of the secondary reflector 13, and returns to the swelled portion 10A. The energy of some of the returned light is absorbed by the material sealed inside the emission region 14 of the swelled portion 10A, while the other portions of the returned light travel towards the reflector 12, and become emergent rays off the reflecting portion 22 of the reflector 12.

As described above, the light source unit 1 of the present embodiment includes the modified layer 18 formed as a boron-diffused layer in the inner surface 10a of the arc tube 10 of silica glass. The modified layer 18 can suppress devitrification (crystallization) of the arc tube 10 as might occur by the heat of the light emitting lamp, and can thus prevent lowering of transmitted light and the strength of the arc tube 10, making it possible to greatly improve lamp lifetime. The (Si—B—O) modified layer 18 has high translucency, and excels in chemical stability and heat resistance, and thus does not easily undergo changes in property even under the high temperature of the lamp during use.

Further, because the modified layer 18 is formed only at the very surface portion of the inner surface 10a of the arc tube 10, devitrification can be suppressed while ensuring strength for the arc tube 10. Devitrification of the arc tube can be suppressed even longer time periods when the modified layer 18 has such a thickness that Si will not be detected on the inner surface 10a of the arc tube 10.

A manufacturing method of the discharge lamp is described below. The following descriptions primarily deal with the characteristic step of the present invention, specifically, formation of the modified layer in the inner surface 10a of the arc tube 10 of the discharge lamp 3, and other manufacturing steps will not be described.

### Discharge Lamp Manufacturing Method of First Embodiment

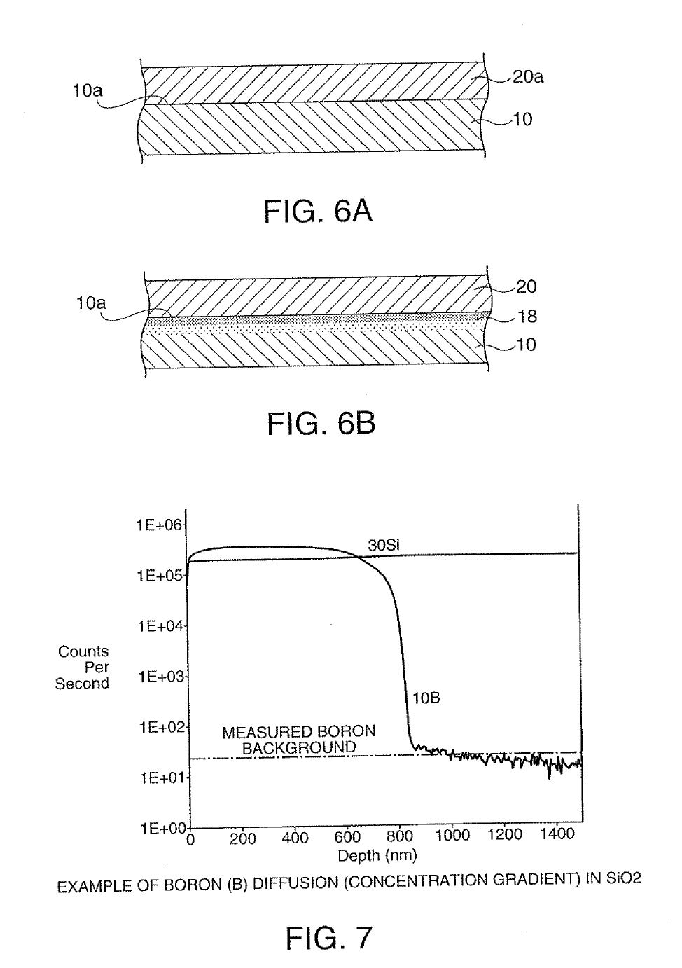

FIG. 5 is a flowchart representing manufacturing steps of the discharge lamp according to the present embodiment. FIGS. 6A and 6B are magnified partial cross sectional views of the arc tube in the manufacturing steps of the discharge lamp.

As represented in FIG. 5, the discharge lamp manufacturing method of the present embodiment includes coating step S1, heat treatment step S2, and electrode installing and luminescent material sealing step S3.

As illustrated in FIG. 6A, a liquid material 20a containing diboron trioxide (B₂O₃) is applied over the inner surface 10a of the arc tube 10 (S1).

After drying the coated liquid material (coated film), the arc tube 10 is heated and calcined at a predetermined temperature (1,000° C. and higher) to melt the solidified microparticles. Then, as illustrated in FIG. 6B, the boron is diffused into the tube wall at the inner surface 10a of the arc tube 10 (S2). The diffusion of the boron in the arc tube (SiO₂) 10 modifies the inner surface 10a (the outermost layer of the tube wall), forming the modified layer 18 of the present embodiment. By being heated, the boron gradually diffuses towards inside from the outermost layer of the inner surface 10a in contact with the liquid material, creating a distribution of a boron concentration that is highest on the outermost layer side, and that gradually becomes lower along the thickness direction of the tube wall. The modified layer 18 thus has a concentration gradient in which the boron concentration gradually becomes lower along the thickness direction of the tube wall away from the outermost layer of the inner surface 10a.

At the time of forming the modified layer 18, the B₂O₃ film 19 is formed on the inner surface 10a of the arc tube 10, i.e., on the modified layer 18. The B₂O₃ film 19 is formed over the whole surface of the modified layer 18.

Thereafter, the electrodes 11a, 11a are installed inside the arc tube 10 provided with the modified layer 18, and mercury and halogen gas are sealed therein (S3) to obtain the discharge lamp 3 of the present embodiment.

In this manner, the liquid material as a dispersion of B₂O₃ microparticles in a medium is applied throughout the inner surface 10a of the arc tube 10, followed by heating and calcining. The method therefore easily forms the modified layer 18 as a boron-diffused layer in the outermost layer of the inner surface 10a. In the present embodiment, boron is diffused only at the very surface portion of the inner surface 10a of the arc tube 10, and the diffused state of the boron in the arc tube 10 can be adjusted according to such factors as heating temperature and heating time. By forming the modified layer 18 with a distribution of a boron concentration that gradually becomes lower along the thickness direction of the tube wall away from the outermost layer of the inner surface of the arc tube, devitrification can be effectively suppressed while preventing lowering of arc tube strength.

FIG. 7 represents an example of a boron (B) diffused state (concentration gradient) in the arc tube (SiO₂) 10. The vertical axis represents concentration; horizontal axis represents depth (nm).

Referring to FIG. 7, the B₂O₃ film 19 is formed on the inner surface 10a of the arc tube 10 in a thickness of about 600 nm. The modified layer 18 is formed at the very surface of the inner surface 10a in a thickness of about 200 nm. As can be seen in FIG. 7, while the boron concentration is substantially constant in the B₂O₃ film 19, the boron in the modified layer 18 at the very surface of the inner surface 10a in contact with the B₂O₃ film 19 has a distribution of a gradually decreasing concentration along the thickness direction of the tube wall away from the outermost layer of the inner surface 10a. Specifically, the boron concentration decreases exponentially along the thickness direction of the tube wall away from the outermost layer of the inner surface 10a.

The figure also shows the measured boron background. The boron concentration is substantially constant over the background at depths above 200 nm from the outermost surface of the silica glass (SiO₂).

By intentionally diffusing boron only in the outermost surface of the arc tube 10, lowering of the softening point and thus the strength of the arc tube 10 can be prevented.

Further, the modified layer 18 formed in the inner surface 10a of the arc tube 10 prevents the arc tube 10 from reacting with the sealed substance (metal halogens) or the tungsten electrodes 11a, 11a in the arc tube 10 during the use of the lamp, thus preventing changes in property and color, and devitrification of the arc tube 10.

Variations of the discharge lamp manufacturing method of the embodiment of the invention are described below.

### Variation 1

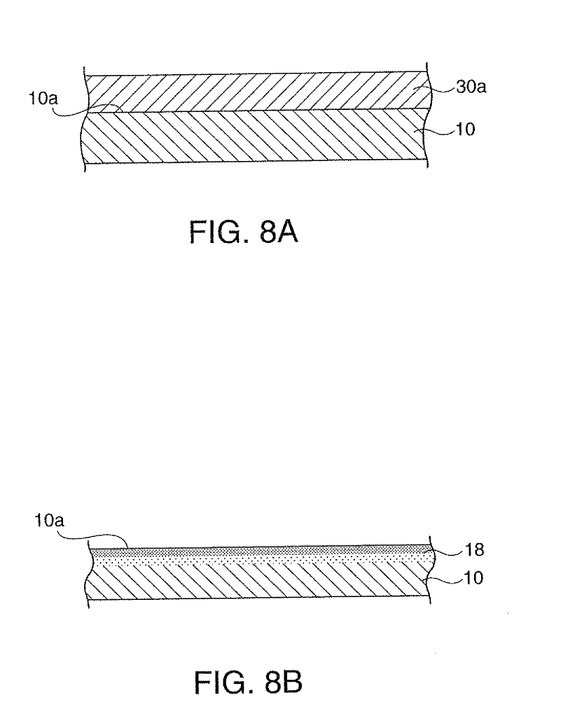

The following describes Variation 1 of the discharge lamp manufacturing method of the embodiment of the invention, with reference to FIGS. 8A and 8B. FIGS. 8A and 83 are magnified cross sectional views illustrating a relevant portion of the arc tube 10 in manufacturing steps of the discharge lamp according to the present variation.

In the discharge lamp manufacturing method of First Embodiment, the modified layer 18 is formed by diffusing boron in the tube wall by the heat treatment performed after applying diboron trioxide (B₂O₃) on the inner surface 10a of the arc tube 10. In the manufacturing method of the discharge lamp 3 of the present variation, boron trifluoride diethyl etherate (liquid material) 30a is applied on the inner surface 10a of the arc tube 10 in coating step S1, as illustrated in FIG. 8A.

The boron trifluoride diethyl etherate 30a is applied using either a dipping method or a dropping method.

After applying the boron trifluoride diethyl etherate 30a throughout the inner surface 10a of the arc tube 10, a heat treatment is performed in an electric furnace. By being heated, the boron diffuses into the tube wall (SiO₂) from the inner surface 10a of the arc tube 10 in contact with the boron trifluoride diethyl etherate 30a, and the modified layer 18 is formed, as illustrated in FIG. 8B.

The manufacturing method of the present variation uses boron trifluoride diethyl etherate ((C₂H₅)₂O.BF₃) as the liquid material, and thus enables the chemically stable (Si—B—O) modified layer 18 to be formed in the inner surface 10a of the arc tube 10. Further, because the modified layer 18 is formed in the tube wall of the arc tube 10, defects such as detachment due to improper adhesion to the arc tube 10 as might occur in the deposition of a devitrification suppressing film on the inner surface 10a of the arc tube 10 can be prevented.

### Variation 2

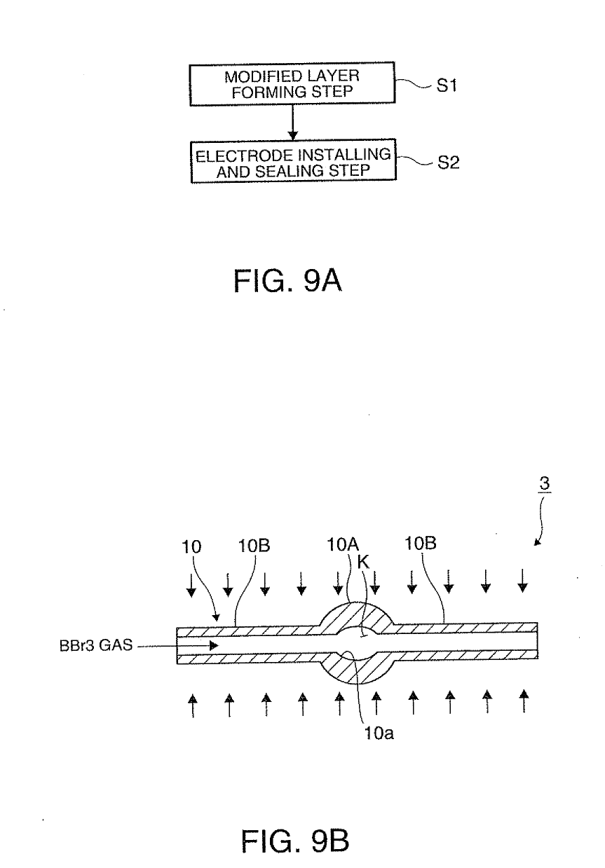

The following describes Variation 2 of the discharge lamp manufacturing method of the embodiment of the invention, with reference to FIGS. 9A and 9B. FIG. 9A is a flowchart representing discharge lamp manufacturing steps of the present variation. FIG. 9B is a magnified cross sectional view illustrating a relevant portion of the arc tube 10 in a manufacturing step of the discharge lamp according to the present variation.

The manufacturing method of the discharge lamp 3 according to the present variation includes, as shown in FIG. 9A, modified layer forming step S1 and electrode installing and luminescent material sealing step S2.

First, as represented in FIG. 9B, the arc tube 10 with open ends to the sealing portions 10B, 10B is prepared, and boron tribromide gas (BBr₃) is flown into the tube through one of the sealing portions 10B towards the other sealing portion 10B. This is performed while heating the arc tube 10 using, for example, an externally installed heater. The boron tribromide gas undergoes pyrolysis and decomposes into boron (B) and bromine (Br) as it passes through the arc tube 10 under heat. The boron reacts with the silicon in the arc tube 10, and diffuses into the inner surface 10a, whereas the bromine is ejected through the other sealing portion 10B of the arc tube 10 without reacting with the silicon in the arc tube 10.

In this manner, the boron produced from the boron tribromide gas by pyrolysis adheres to the inner surface 10a of the arc tube 10, and diffuses into the tube wall to form the modified layer 18 (S1). The thickness of the modified layer 18 is adjusted according to such factors as the flow rate of the boron tribromide gas, and heating temperature.

Thereafter, the electrodes 11a, 11a are installed in the arc tube 18 provided with the modified layer 18, and mercury and halogen gas are sealed therein to obtain the discharge lamp 3 (S2).

In the manufacturing method of the present variation, the boron tribromide gas is flown into the arc tube 10 of silica glass while heating the arc tube 10, and the boron tribromide gas is decomposed by pyrolysis in the arc tube 10 to diffuse the boron into the inner surface 10a of the arc tube 10. The boron produced by the pyrolysis reacts with the inner surface 10a of the arc tube 10, and diffuses inside to form the modified layer 18 throughout the inner surface 10a of the arc tube 10.

The manufacturing method provides easy control of the flow rate of the boron-containing gas flown into the arc tube 10, and thus allows for adjustment of the extent of boron diffusion in the inner surface 10a of the arc tube 10, making it possible to form the modified layer 18 in a desired thickness in the inner surface 10 of the arc tube 10.

In this variation, because the boron tribromide gas is flown while heating the arc tube 10 throughout, the modified layer 18 is formed not only in the inner surface 10a in the swelled portion 10A of the arc tube 10 but in the inner surface of the sealing portions 10B. The modified layer 18 can sufficiently suppress lowering of the transmitted light of the arc tube 10 during emission when formed at least in the inner surface of the swelled portion 10A. Nonetheless, the modified layer 18 also may be formed in the inner surface of the sealing portions 10B, 10B.

In this variation, the boron tribromide gas is used as the boron-containing gas. However, the boron-containing gas is not limited to this. For example, a boron trichloride (BCl₃) gas and a boron trifluoride (BF₃) gas also can be used.

Other embodiments of the invention are described below.

The light source units of the embodiments below have substantially the same basic configuration as that described in First Embodiment, but differ from the foregoing embodiment in the structure of the discharge lamp. Accordingly, the following descriptions mainly deal with the discharge lamp structure, and the common features will not be described. Further, in the appended figures referred to in the following descriptions, the same reference numerals are used for the constituting elements common to those described in FIG. 1 to FIG. 7.

### Second Embodiment

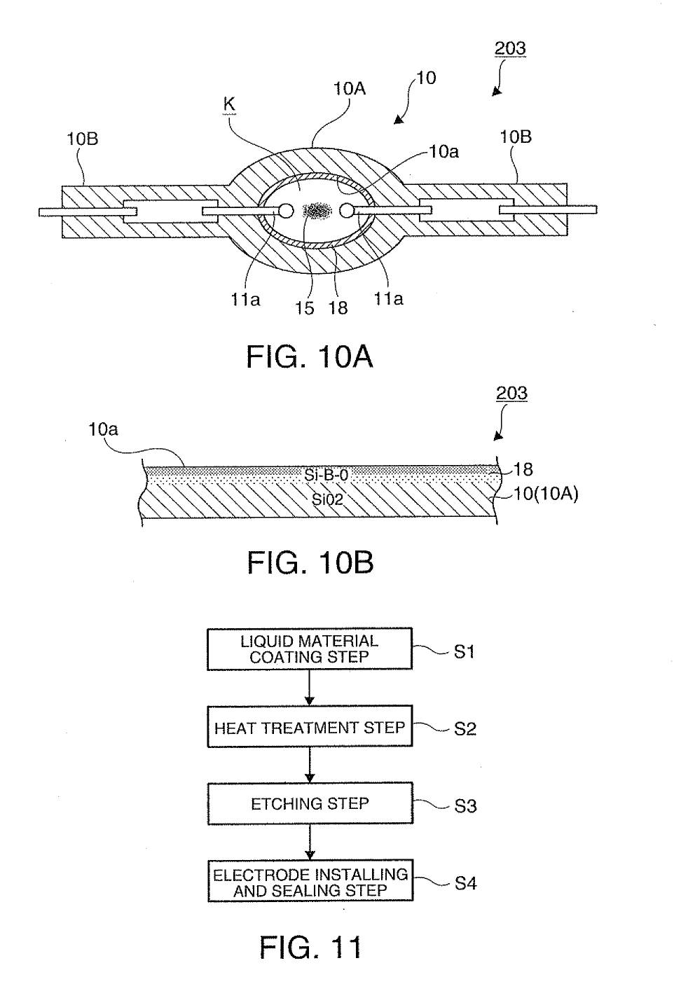

A discharge lamp of Second Embodiment of the invention is described below with reference to FIGS. 10A and 10B. FIG. 10A is a cross sectional view illustrating a schematic structure of the discharge lamp of Second Embodiment. FIG. 10B is a magnified cross sectional view illustrating a relevant portion of the discharge lamp.

The discharge lamp 3 of First Embodiment is configured to include the B₂O₃ film 19 formed on the modified layer 18. In the discharge lamp 203 of the present embodiment, as illustrated in FIGS. 10A and 10B, the whole surface of the modified layer 18 formed in the inner surface 10a of the arc tube 10 is exposed to emission space K. The modified layer 18 itself is the same as that of the foregoing embodiment.

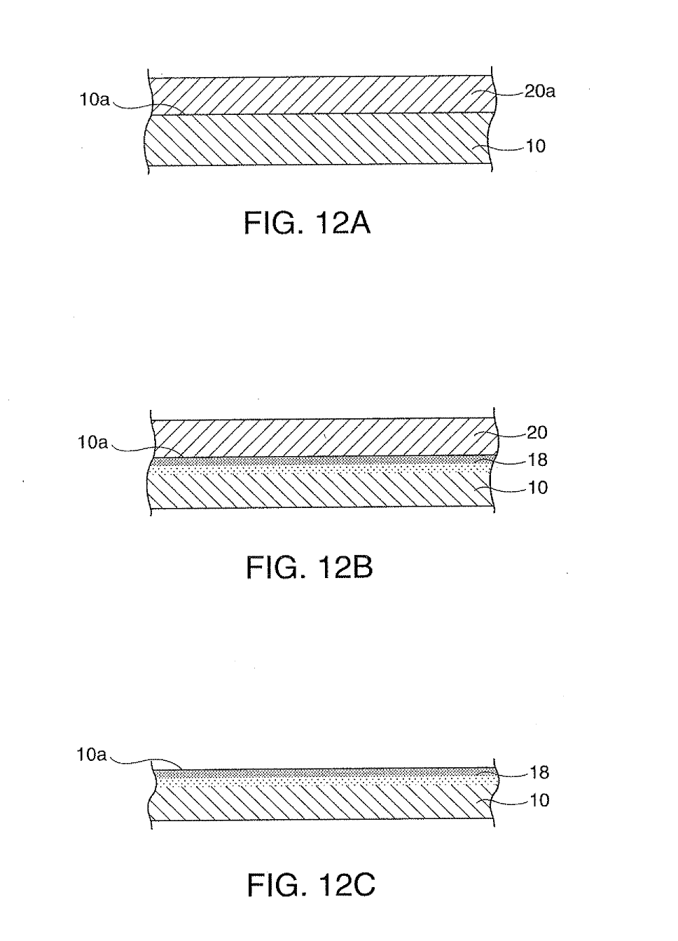

FIG. 11 is a flowchart representing a discharge lamp manufacturing method of Second Embodiment. FIGS. 12A to 12C are magnified cross sectional views showing a relevant portion of the arc tube 10 in manufacturing steps.

As shown in FIG. 11, the manufacturing method of the discharge lamp 203 of the present embodiment includes coating step S1, heat treatment step S2, etching step S3, and electrode installing and luminescent material sealing step S4.

First, as illustrated in FIG. 12A, a liquid material 20a containing diboron trioxide (B₂O₃) is applied to the inner surface 10a of the arc tube 10 (S1). After drying the liquid material (coated film) 20a, as illustrated in FIG. 12B, the arc tube 10 is heated and calcined at a predetermined temperature (1,000° C. and higher) to diffuse the boron into the inner surface 10a of the arc tube 10 (S2). The diffusion of the boron in the arc tube (SiO₂) 10 modifies the outermost layer of the inner surface 10a, and the modified layer 18 is formed. At the same time, the B₂O₃ film 19 is formed on the inner surface 10a (on the modified layer 18) of the arc tube 10. The B₂O₃ film 19 is formed over the whole surface of the modified layer 18.

Then, as illustrated in FIG. 12C; the B₂O₃ film 19 is removed by etching, exposing the modified layer 18 to emission space K (S3).

Thereafter, the electrodes 11a, 11a are installed inside the arc tube 10 exposing the modified layer 18, and mercury and halogen gas are sealed therein (S4) to obtain the discharge lamp 3 of the present embodiment.

In the manufacturing method of the present embodiment, the B₂O₃ film 19 formed simultaneously with the modified layer 18 is removed by etching to expose the surface of the modified layer 18.

In the presence of the B₂O₃ film 19 on the inner surface 10a of the arc tube 10, the boron may evaporate from the B₂O₃ film 19 under the high temperature of the lamp during use, and deteriorate the tungsten electrodes 11a, 11a installed in the arc tube 10.

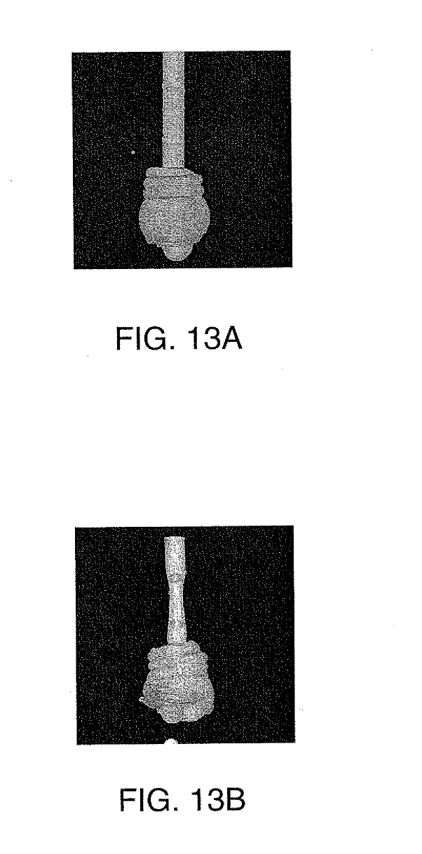

FIGS. 13A and 13B show states of the electrode 11a in the presence of the B₂O₃ film on the inner surface of the arc tube. FIG. 13A shows the initial state of the electrode 11a before the lamp is turned on. FIG. 13B shows the deteriorated state of the electrode 11a after the emission time of 500 H.

As clearly shown in FIGS. 13A and 13B, in the presence of the B₂O₃ film on the inner surface of the arc tube, the shape of the electrode 11a is different before and after the emission of the lamp. The defined curved surface at the tip of the electrode 11a observed before the emission collapses after a predetermined emission time, deforming the electrode 11a to such an extent that the original shape is not recognizable. Deformation also occurs along the axis, making the shaft very narrow.

Such deformation is considered to be due to the boron adversely affecting the tungsten electrode 11a after evaporating from the B₂O₃ film under the high temperature of the emitting lamp.

Thus, in the present embodiment, the B₂O₃ film that can accelerate deterioration of the tungsten electrodes 11a, 11a is etched away from the inner surface 10a of the arc tube 10.

By removing the B₂O₃ film that can deteriorate the electrodes 11a, 11a, there will be no evaporation of the boron from the B₂O₃ film under the high temperature of the emitting lamp, and the lifetime of the electrodes 11a, 11a can be increased.

### Third Embodiment

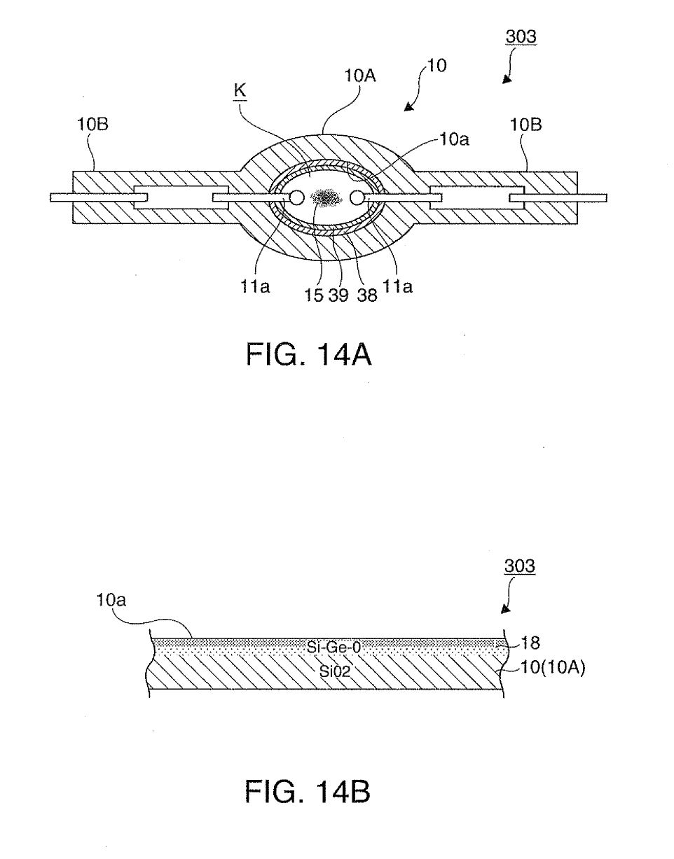

A discharge lamp of Third Embodiment of the invention is described below with reference to FIGS. 14A and 14B. FIGS. 14A and 14B are cross sectional views illustrating a schematic structure of the discharge lamp of Third Embodiment.

In contrast to the discharge lamps 3 and 203 of the foregoing First and Second Embodiments configured to include the (Si—B—O) modified layer as the boron-diffused layer formed in the inner surface 10a of the arc tube 10, a discharge lamp 303 of the present embodiment is configured to include, as illustrated in FIGS. 14A and 14B, a (Si—Ge—O) modified layer 38 as a germanium-diffused layer formed in the inner surface 10a of the arc tube 10.

The modified layer 38 is formed only in the outermost layer portion of the inner surface 10a of the arc tube 10, and has a distribution of a germanium concentration that gradually decreases along the thickness direction of the tube wall away from the outermost layer of the inner surface 10a of the arc tube 10. Preferably, the germanium concentration has a concentration gradient that decreases exponentially (see FIG. 4).

The modified layer 38 has a thickness of, for example, 0.01 μm or more and 1 μm or less, though it depends on such factors as the type of the luminescent material sealed in the arc tube 10. The preferable thickness of the modified layer 38 is 0.02 μm or more and 0.5 μm or less.

With the modified layer 38 formed at the very surface of the inner surface 10a of the arc tube 10, the arc tube 10 can be prevented from crystallizing, making it possible to suppress devitrification of the arc tube 10 for extended time periods.

A GeO₂ film 39 is formed on the modified layer 38, covering the whole surface of the modified layer 38. The GeO₂ film 39 has a thickness of, for example, 0.1 μm or more and 10 μm or less, preferably 0.2 μl or more and 5 μm or less.

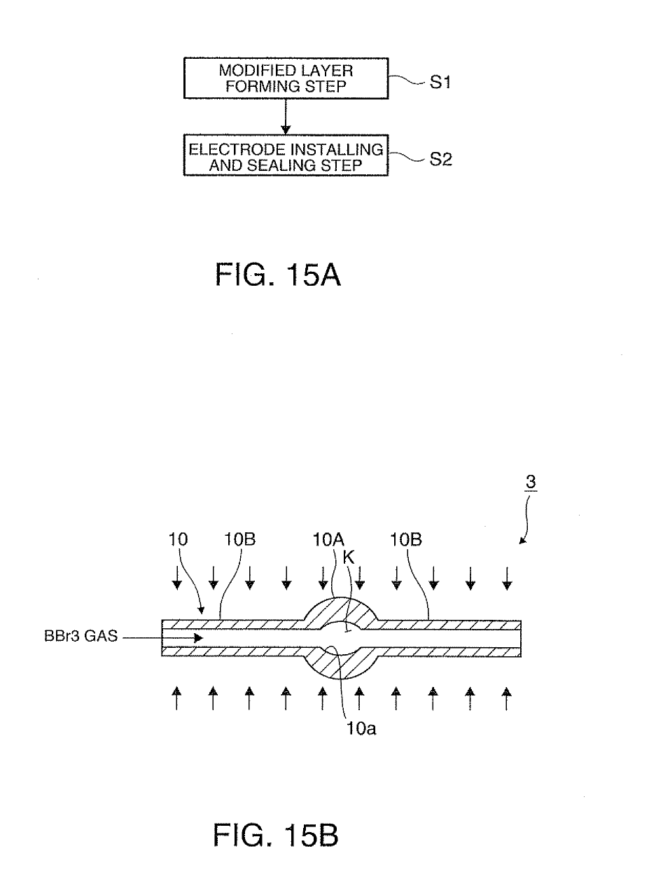

A manufacturing method of the discharge lamp 303 of the present embodiment is described below. FIG. 15A shows a flowchart of the discharge lamp manufacturing method of Third Embodiment. FIG. 15B is a magnified cross sectional view illustrating a relevant portion of the arc tube 10 in a manufacturing step.

The manufacturing method of the discharge lamp 303 of the present embodiment includes, as represented in FIG. 15A, modified layer forming step S1, and electrode installing and luminescent material sealing step S2.

First, as illustrated in FIG. 15B, the arc tube with open ends to the sealing portions 10B, 10B is prepared, and monogermane gas (GeH₄) is flown into the tube through one of the sealing portions 10B towards the other sealing portion 10B. This is performed while heating the arc tube 10 using, for example, an externally installed heater. The monogermane gas (GeH₄) undergoes pyrolysis and decomposes into germanium (Ge) and hydrogen (H) as it passes through the arc tube 10 under heat. The germanium reacts with the silicon in the arc tube 10, and diffuses into the inner surface, whereas the hydrogen is ejected through the other sealing portion 10B of the arc tube 10 without reacting with the silicon in the arc tube 10.

In this manner, the germanium produced from the monogermane gas by pyrolysis adheres to the inner surface 10a of the arc tube 10, and diffuses into the tube wall to form the modified layer 38 (S1). The thickness of the modified layer 38 is adjusted according to such factors as the flow rate of the monogermane gas, and heating temperature.

Thereafter, the electrodes 11a, 11a are installed in the arc tube 10 provided with the modified layer 38, and mercury and halogen gas are sealed therein to obtain the discharge lamp 303 (S2).

In the manufacturing method of the present embodiment, the monogermane gas is decomposed by pyrolysis in the arc tube 10 as it is flown into the arc tube 10 of silica glass under heat. The germanium (Ge) produced by the pyrolysis reacts with the inner surface 10a (Si) of the arc tube 10, and diffuses into the tube wall to form the modified layer 38 throughout the inner surface 10a of the arc tube 10. Because only the germanium produced by the pyrolysis reacts with the inner surface 10a of the arc tube 10, and because the hydrogen that does not react with the arc tube 10 is ejected out of the arc tube 10, the hydrogen does not remain in the arc tube and is not sealed. There accordingly will be no moisture or the like in the emission space during emission, and the devitrification-suppressing effect improves.

In this embodiment, because the monogermane gas is flown while heating the arc tube 10 throughout, the modified layer 38 is formed not only in the inner surface 10a in the swelled portion 10A of the arc tube 10 but in the inner surface of the sealing portions 10B, 10B. The modified layer 38 can sufficiently suppress the devitrification (lowering of transmitted light) of the arc tube 10 during emission when formed at least in the inner surface of the swelled portion 10A. Nonetheless, the modified layer 38 also may be formed in the inner surface of the sealing portions 10B, 10B.

Further, because the monogermane gas is flown as the germanium-containing gas, only the germanium (Ge) produced by the pyrolysis reacts with the inner surface 10a (Si) of the arc tube 10, and the hydrogen (H) that does not react with the arc tube 10 is ejected out of the arc tube 10. Further, because the flow rate of the monogermane gas flown into the arc tube 10 can easily be controlled, the extent of germanium diffusion in the inner surface 10a of the arc tube 10 can be adjusted, and the modified layer 38 can be formed in a desired thickness in the inner surface 10a of the arc tube 10.

In the present embodiment, the monogermane gas is flown as the germanium-containing gas. However, the germanium-containing gas is not limited to this. For example, a digermane (Ge₂H₆) gas and a trigermane (Ge₃H₈) gas also can be used.

### Projector

A projector using the light source unit of the foregoing embodiments is described below.

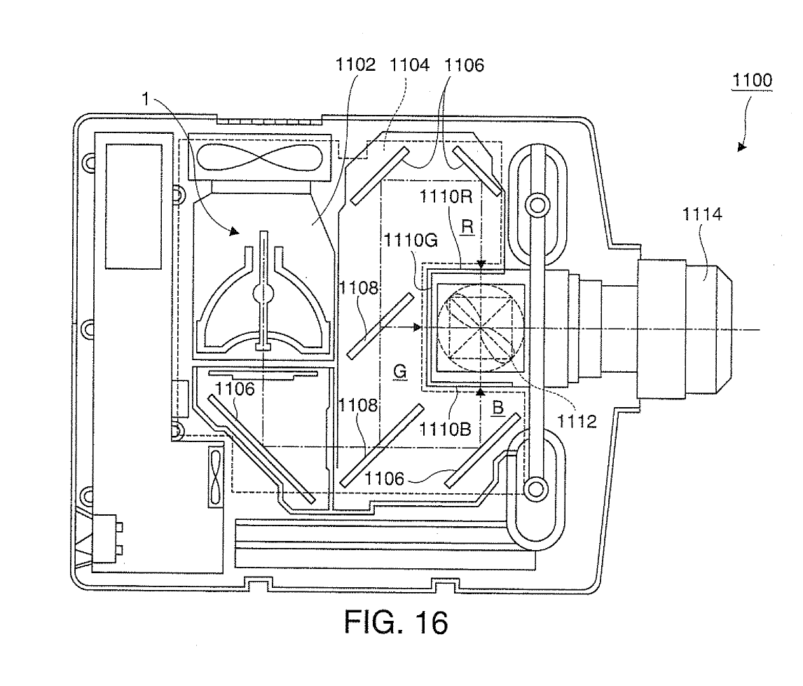

FIG. 16 is a plan view illustrating an exemplary configuration of the projector. As illustrated in the figure, a projector 1100 includes a lamp unit 1102 provided with the light source unit 1 of the embodiments of the invention. The projected light emitted by the lamp unit 1102 is separated into the three primary colors of RGB with four mirrors 1106 and two dichroic mirrors 1108 disposed in a light guide 1104, and is incident on liquid crystal panels (light modulating units) 1110R, 1110B, and 11106 provided as light valves for the respective primary colors.

The liquid crystal panels 1110R, 1110B, and 1110G are driven with the primary color signals of RGB, respectively, supplied from an image signal processing circuit. The light modulated by the liquid crystal panels is incident on a dichroic prism 1112 from three different directions. The dichroic prism 1112 reflects the red light and blue light 90°, while allowing the green light to pass straight through. Images of the respective colors are synthesized, and a color image is projected onto a screen or the like through a projection lens 1114 (projection unit). Concerning the display images produced by the liquid crystal panels 11108, 1110B, and 1110G, the display image by the liquid crystal panel 1110G needs to be flipped horizontally with respect to the display images of the liquid crystal panels 1110R and 1110B.

The projector 1100 includes the light source unit 1 of the foregoing embodiments. Because devitrification can be suppressed for extended time periods in the light source unit 1, highly bright illumination light can be emitted over extended time periods. The projector 1100 thus has a long lifetime, and can produce a high-quality, reliable projection image. Further, because the light source unit 1 is small, the overall size and weight of the projector can be reduced.

The projector 1100 of this embodiment includes the liquid crystal panels as the light modulating units. However, the light modulating units are not limited to this, and, for example, micromirror-type light modulating devices can generally be used, as long as incident light is modulated according to image information. For example, a DMD® (Digital Micromirror Device) can be used as such a micromirror-type light modulating device. When a micromirror-type light modulating device is used, neither an incident polarizer or an outgoing polarizer, nor a polarization converter is necessary.

The light source unit 1 of the foregoing embodiments is used for the projector 1100 of a transmission-type liquid crystal system. However, the invention is not limited to this. The same effects can be obtained when the light source unit 1 is used for a LCOS (Liquid Crystal On Silicon) projector of a reflection-type liquid crystal system.

The light modulating units of this embodiment may be of a three-panel type that uses three liquid crystal panels, or of a single-panel type that uses only one liquid crystal panel. When the single-panel type is used, the color separation optical system and the color synthesis optical system of the illumination optical system are not required.

The light source unit 1 is suited for a front-type projector that projects an optic image over an externally installed projection surface. However, the light source unit 1 is also applicable to a rear-type projector that has a screen within the projector, and that projects an optic image over the internal screen.

The invention has been described with respect to certain preferred embodiments with reference to the appended figures. However, the invention is not limited to these exemplary embodiments, and the embodiments in the foregoing detailed explanation may be combined. The details of the invention may be applied in many different variations or modifications within the technical ideas of the patent claims set forth below, as may be evident to a person ordinary skilled in the art. It is understood that such variations and modifications also fall within the technical scope of the invention.

The light source unit 1 of the foregoing embodiments is suitable as a light source for projectors. However, the light source unit, with its small size and lightness, is also applicable to other optical instruments. For example, the light source unit can be suitably applied to illuminations for airplanes, ships, and automobiles, and to room illuminations.

The entire disclosure of Japanese Patent Application No. 2009-251121, filed Oct. 30, 2009 is expressly incorporated by reference herein.

What is claimed is:

1. A discharge lamp comprising:
an arc tube made from silica glass, and
a modified layer as a boron- or germanium-diffused layer formed in an inner surface of the arc tube.

2. The discharge lamp according to claim 1, wherein the modified layer is a (Si—B—O) layer or a (Si—Ge—O) layer.

3. The discharge lamp according to claim 1, wherein the modified layer is exposed to an emission space of the arc tube.

4. The discharge lamp according to claim 1, wherein the modified layer has a distribution of boron or germanium concentration that gradually becomes lower towards inside away from an outermost layer of the inner surface of the arc tube.

5. The discharge lamp according to claim 1, wherein the modified layer has boron or germanium concentration gradient that exponentially becomes lower towards inside away from an outermost layer of the inner surface.

6. The discharge lamp according to claim 1, wherein the modified layer has a thickness of 0.01 μm or more and 1 μm or less.

7. The discharge lamp according to claim 6, wherein the modified layer has a thickness of 0.02 μm or more and 0.5 μm or less.

8. A method for manufacturing a discharge lamp, the method comprising steps of:
applying a boron-containing liquid material on an inner surface of an arc tube made from silica glass; and
diffusing the boron into the inner surface of the arc tube by heat treatment.

9. The method according to claim 8, wherein the liquid material is diboron trioxide.

10. The method according to claim 8, wherein the liquid material is boron trifluoride diethyl etherate.

11. The method according to claim 8, further comprising:
exposing a modified layer by removing a B₂O₃ film formed by a heat treatment that follows the application of the boron-containing liquid material on the inner surface of the arc tube; and
installing a tungsten electrode in the arc tube.

12. A method for manufacturing a discharge lamp, the method comprising steps of:
flowing a boron-containing gas or a germanium-containing gas into an arc tube made from silica glass; and
causing the flow of the boron-containing gas or the germanium-containing gas to undergo pyrolysis in the arc tube so as to diffuse the boron or the germanium into an inner surface of the arc tube.

13. The method according to claim 12, wherein the boron-containing gas is any one of boron trichloride gas, boron trifluoride gas, and boron tribromide gas.

14. The method according to claim 12, wherein the germanium-containing gas is any one of monogermane (GeH₄) gas, digermane (Ge₂H₆) gas, and trigermane (Ge₃H₈) gas.

15. A projector comprising the discharge lamp according to claim 1.

16. The projector according to claim 15, wherein the modified layer is a (Si—B—O) layer or a (Si—Ge—O) layer.

17. The projector according to claim 15, wherein the modified layer is exposed to an emission space of the arc tube.

18. The projector according to claim 15, wherein the modified layer has a distribution of boron or germanium concentration that gradually becomes lower towards inside away from an outermost layer of the inner surface of the arc tube.

19. The projector according to claim 15, wherein the modified layer has boron or germanium concentration gradient that exponentially becomes lower towards inside away from an outermost layer of the inner surface.

20. The projector according to claim 15, wherein the modified layer has a thickness of 0.01 μm or more and 1 μm or less.
